(19) United States
(12) Patent Application Publication
(10) Pub. No.: US 2025/0031911 A1
(43) Pub. Date: Jan. 30, 2025

(54) Integrated Removable Food Strainer

(71) Applicant: Troy Turner, Wichita, KS (US)

(72) Inventor: Troy Turner, Wichita, KS (US)

(21) Appl. No.: 18/735,160

(22) Filed: Jun. 5, 2024

(51) Int. Cl. A47J 43/28; B01D 35/28; B65D 17/34; B65D 43/02; B65D 51/22; B65D 51/24

(52) U.S. Cl. CPC A47J 43/286; B01D 35/28; B65D 17/34; B65D 43/0202; B65D 51/228; B65D 51/24; B01D 2201/40; B65D 2251/0018; B65D 2251/0071; B65D 2517/0049; B65D 2543/00092

(57) ABSTRACT

The removable integrated food strainer is a novel invention designed to simplify the process of draining liquids and rinsing residual materials from canned goods. It consists of a specially designed built-in strainer that is integrated into the pre-manufactured can or container of various canned goods upon purchase. This unique design provides both convenience to the user and cost efficiency as additional household kitchen utensils are not required to drain said canned goods.

### CROSS REFERENCE TO RELATED APPLICATION

The present application claims priority to the earlier filed U.S. Provisional Patent Application having application No. 63/647,949 with a file date of May 15, 2024, and hereby incorporates subject matter of the provisional application in its entirety.

### FIELD OF THE INVENTION

This invention relates to a pre-fabricated strainer that has been integrated into a can or container during the manufacturing process, to provide consumers with the convenience of a built-in straining mechanism for their canned goods, without the inconvenience of having to obtain and or purchase an additional kitchen utensil for draining liquids from canned goods.

### BACKGROUND OF THE INVENTION

Conventional methods for draining liquids from canned goods, lack efficiency and precision, leading to spills and inconvenience. Existing methods of using full size strainers and the lids from canned goods, do not provide optimal control over the draining process. Therefore, a need exists for an integrated, removable, and disposable food strainer system that offers convenience, precision, and ease of use.

The present invention illustrated in FIGS. 1 to 7, relates to an integrated removable food strainer, built-in to a sealed food safe can or container, which is integrated within the lid or opening mechanism of a can or container, made from various food safe materials providing a convenient and mess free solution for straining liquids from various types of cans and containers.

### SUMMARY

The present invention relates to an integrated removable food strainer, built-in to a sealed food safe aluminum, tin plate, or various material can or container, which is designed to facilitate the efficient draining of liquid in a hassle-free manner, without the need for additional cookware items.

The integrated removable food strainer is integrated into the can or container and is conveniently located under the lid of the can or container.

The integrated removable food strainer can be composed of a perforated surface with multiple perforation patterns, positioned within the opening mechanism of a can or container located beneath the lid of said can or container.

The integrated removable food strainer can be composed of a mesh surface positioned within the opening mechanism of an aluminum can located beneath the lid of said aluminum can.

The integrated removable food strainer can be made from a perforated surface that is vacuum sealed within the opening mechanism of an aluminum can located underneath the can's lid

The integrated removable food strainer can be constructed from multiple food safe materials.

### BRIEF DESCRIPTION OF THE DRAWINGS

A comprehensive description of the preferred embodiment of the integrated removable food strainer will be provided hereafter, by way of example, with reference to the accompanying figures in the drawings:

FIG. 1 illustrates a top view of the integrated removable food strainer with a perforated surface positioned within the opening mechanism of a can located beneath the lid of said can or container,

FIG. 2 illustrates a top view of the integrated removable food strainer with a mesh surface positioned within the opening mechanism of an aluminum can located beneath the lid of said aluminum can;

FIG. 3 illustrates a top view of the integrated removable food strainer with a perforated surface that is vacuum sealed within the opening mechanism of a can located underneath the can's lid;

FIG. 4 illustrates a rendered left side view of typical food safe can with a perforated surface of the integrated removable food strainer positioned within the opening mechanism with said perforated surface allowing liquids to drain from the can while retaining solid content;

FIG. 5 illustrates a top view of a standard food safe can without the integrated removable food strainer, to show the fastening means for securing the integrated removable food strainer;

FIG. 6 illustrates the top view of a standard food safe can with a side view perspective to show that the integrated removable food strainer is a removable component attachable to the opening mechanism of the can or container,

FIG. 7 illustrates the top view of a standard food safe can with a rendering showing that the integrated removable food strainer may be removed from the opening of the can or container.

### DETAILED DESCRIPTION OF THE INVENTION

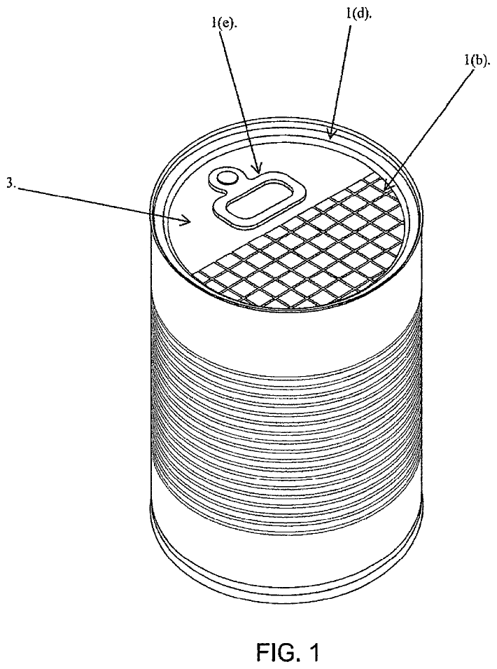

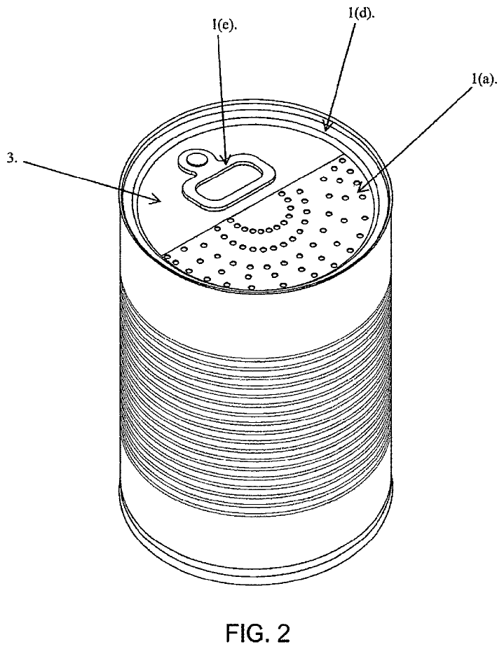

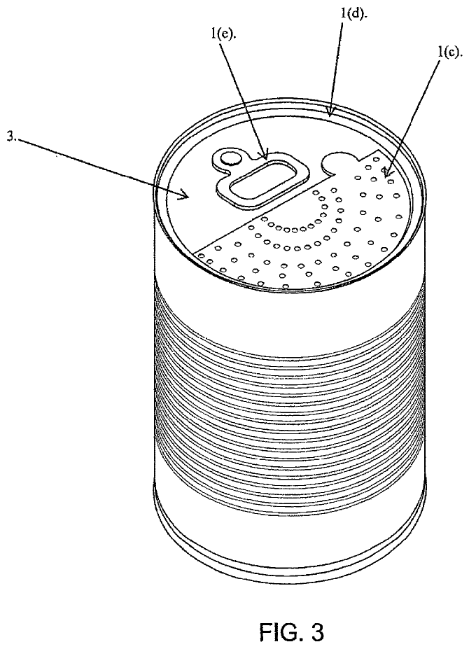

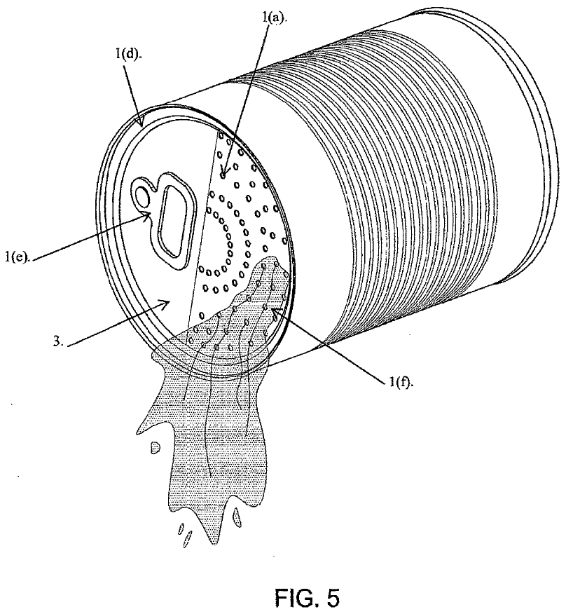

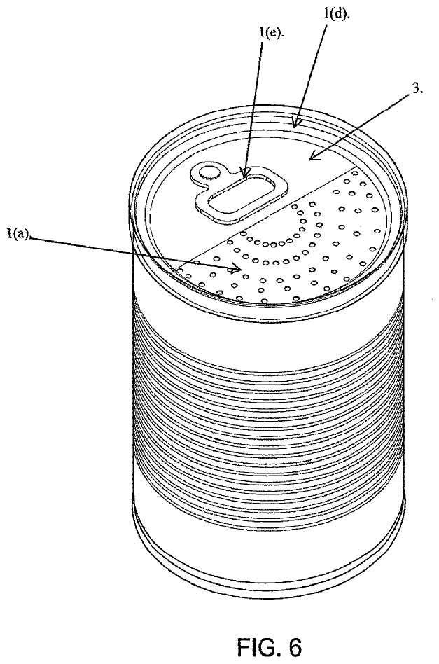

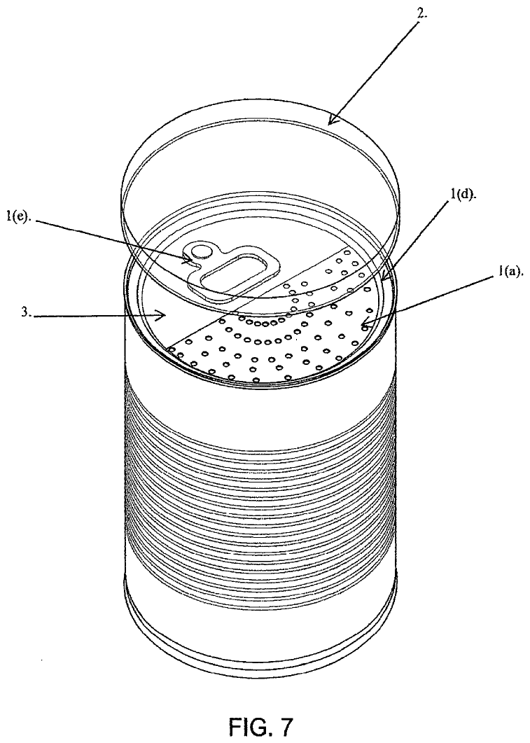

Illustrated in FIGS. 1 to 7, the removable integrated food strainer is comprised of a perforated or mesh surface, positioned within the lid or opening mechanism of the can or container.

As can be seen in FIGS. 1 to 3, the perforated strainer service may have perforations of various patterns, size, and density for optimal drainage of various types of liquids and solids.

Said straining surface may be free standing, resting within a perforated lip surrounding the circumference of the outside edge of the can or container, or vacuum sealed to the opening of the can or container underneath the lid of the can or container as best seen in FIGS. 1 to 3, all of which may be integrally formed during the manufacturing process.

The straining surface is configured as a removable component to the can or container in which it resides which may be seen in FIGS. 1 to 7.

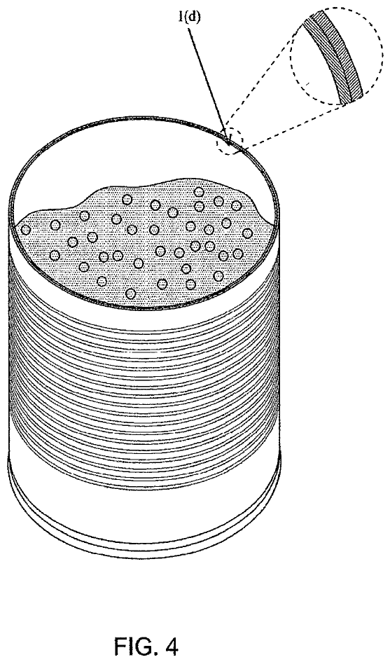

As best illustrated in FIG. 4, the mesh or perforated surface of the food strainer allows liquid to drain from the can while retaining solid contents, such as food.

As may be seen in FIG. 1 to 7, the strainer may be shaped to conform to the contour of the container opening ensuring a secure fit or may be free standing within the the opening mechanism of the can or container.

The strainer shall be equipped with certain mechanisms, such as a pull tab, for removal purposes, so that access to drained contents may be facilitated, as seen in FIGS. 1 to 7.

The removable integrated food strainer may be constructed from all food safe materials including but not limited to stainless steel, silicone, polyethylene terephthalate, high-density polyethylene, low-density polyethylene, polyethylene terephthalate glycol, polycarbonate, polyethylene napthalate, bamboo, aluminum, and steel coated tin.

The average dimensions of the integrated food strainer may be, but is not limited to, the circumference of the average width of the opening mechanism of a tin plate or aluminum can used to store various canned vegetables, fruits, beans and other edible items, which is approximately 9 to 10 inches (23 to 25 centimeters) in circumference. The average thickness of the integrated strainer may be, but is not limited to, 0.1 millimeters to 0.15 millimeters.

To use the removable integrated can strainer, the user simply opens the lid of the can or container and is met with the pre-stalled strainer. The perforated or mesh design allows liquid to drain out while retaining solids inside the can. This also allows for the user to drain and/or rinse the contents within the container and/or can. Once drained, the strainer may be easily removed and disposed of or recycled.

1. A multi-functional removable food strainer integrated into the opening mechanism of a food safe can or other food safe containers.
(a) A perforated surface positioned within the opening mechanism of a can or container located beneath the lid of said can or container.
(b) A mesh surface positioned within the opening mechanism of aluminum can located beneath the lid of said aluminum can.
(c) A perforated surface vacuum sealed within de opening mechanism of an aluminum can located beauty the lid of said aluminum can.
(d) Fastening means for securing strainer described in 1a through 1c
(e) Mechanism for removing strainer described in 1a through 1c
(f) Wherein the mesh and/or perforated surface allows liquids to drain from the can or container while retaining solid content.

2. The removable integrated food strainer of claim 1, wherein the strainer is a removable component attachable to the opening mechanism of the can or container.

3. The removable integrated food strainer of claim 1, wherein the strainer is integrally formed within or around the opening mechanism of the can or container
